(19) United States
(12) Patent Application Publication
(10) Pub. No.: US 2025/0322837 A1
(43) Pub. Date: Oct. 16, 2025

(54) BACKGROUND NOISE FILTERING SYSTEM

(71) Applicant: BitHuman Inc, SAN FRANCISCO, CA (US)

(72) Inventors: Joseph P. Robinson, Salisbury, MA (US); Yun Fu, Newton, MA (US)

(73) Assignee: BitHuman Inc, SAN FRANCISCO, CA (US)

(21) Appl. No.: 18/634,991

(22) Filed: Apr. 14, 2024

(51) Int. Cl. G10L 21/0208; G06V 40/16; G10L 17/00

(52) U.S. Cl. CPC G10L 21/0208; G06V 40/174; G10L 17/00

(57) ABSTRACT

Embodiments of the present disclosure may include a background noise filtering system based on multimodal AI, including a server. Embodiments may also include one or more cameras coupled to the server.

### BACKGROUND OF THE INVENTION

Embodiments of the present disclosure may include a background noise filtering system based on multimodal AI coupled to a server. Embodiments may also include one or more cameras and one or more microphones coupled to the server.

### BRIEF SUMMARY

Embodiments of the present disclosure may include a background noise filtering system based on multimodal AI, including a server. Embodiments may also include one or more cameras coupled to the server. Embodiments may also include one or more microphones coupled to the server. Embodiments may also include a set of virtual agents coupled to the one or more cameras and the server.

In some embodiments, the set of virtual agents may be configured to be displayed in LED/OLED displays, Android/iOS tablets, Laptops/PCs, smartphones, or VR/AR goggles. In some embodiments, a set of multi-layer info panels coupled to the one or more processors may be configured to overlay graphics on top of the set of virtual agents. In some embodiments, any of the set of virtual agents may be configured to be displayed with an appearance of an actual human or a humanoid or a cartoon character or an animated talking object.

In some embodiments, any of the set of virtual agents' gender, age and ethnicity may be determined by the artificial Intelligence's analysis on input from the user. In some embodiments, any of the set of customer-facing virtual agents may be configured to be displayed in whole or half body portrait mode. In some embodiments, the virtual agent serves to interact the users.

In some embodiments, the artificial intelligence engine may be configured for real-time speech recognition, speech-to-text generation, real-time dialog generation, text-to-speech generation, real-time lip animation to sync with speech, and avatar generation. In some embodiments, the artificial intelligence engine may be configured to emulate different voices and use different languages.

Embodiments may also include a device coupled to the server. In some embodiments, the device including an artificial intelligence engine and one or more processors and memory storing instructions that, when executed by one of the processors, cause the device to obtain in real-time, from any of the one or more cameras, a set of videos of a plurality of individuals at a location.

Embodiments may also include select, from the set of videos, for each individual, a preferred facial image for the individual. Embodiments may also include determine whether lip movement of one of the individuals may be visible in the set of images. Embodiments may also include select, based on whether the lip movement of one of the individuals may be visible in the set of images, at least one of a facial recognition algorithm and an audio algorithm to determine which individual may be speaking.

In some embodiments, the lip movements. Embodiments may also include record audio from the one of the individuals by the one or more microphones. Embodiments may also include compare the audio from the one of the individuals and pre-recorded audios that belong to the one of the individuals. Embodiments may also include compare the preferred facial image of the one of the individuals and pre-recorded facial images of the one of the individuals.

Embodiments may also include determine identification of the one of the individuals who may be speaking and. Embodiments may also include filter, based on whether the lip movement of one of the individuals may be visible in the set of images and the identification of the one of the individuals, other sounds from the others of the plurality of individuals, and background sounds.

Embodiments of the present disclosure may also include a method to identify speakers and filter background noise with Artificial intelligence including obtaining in real-time, by one or more cameras, a set of videos of a plurality of individuals at a location. In some embodiments, the set of virtual agents may be configured to be displayed in LED/OLED displays, Android/iOS tablets, Laptops/PCs, smartphones, or VR/AR goggles.

In some embodiments, a set of multi-layer info panels coupled to the one or more processors may be configured to overlay graphics on top of the set of virtual agents. In some embodiments, any of the set of virtual agents may be configured to be displayed with an appearance of a real human or a humanoid or a cartoon character. In some embodiments, any of the set of virtual agents' gender, age and ethnicity may be determined by the artificial Intelligence's analysis on input from the user.

In some embodiments, any of the set of customer-facing virtual agent may be configured to be displayed in whole body or half body portrait mode. In some embodiments, the artificial intelligence engine may be configured for real-time speech recognition, speech to text generation, real-time dialog generation, text to speech generation, voice-driven animation, and human avatar generation.

In some embodiments, the artificial intelligence engine may be configured to emulate different voices and use different languages. In some embodiments, a device with an artificial intelligence engine may be configured to be connected to one or more cameras and the set of virtual agent. Embodiments may also include selecting, from the set of videos for each individual, a preferred facial image for the individual.

In some embodiments, a set of virtual agents coupled to the one or more cameras. Embodiments may also include determining whether lip movement of one of the individuals may be visible in the set of images. Embodiments may also include selecting, based on whether the lip movement of one of the individuals may be visible in the set of images, at least one of a facial recognition algorithm and an audio algorithm to determine which individual may be speaking.

In some embodiments, the lip movements. Embodiments may also include record audio from the one of the individuals by one or more microphones. Embodiments may also include comparing the audio from the one of the individuals and pre-recorded audio that belongs to the one of the individuals if there may be a pre-recorded audio exists.

Embodiments may also include saving the audio from the one of the individuals with a tag attached to the one of the individuals if there may be no pre-recorded audio exists. Embodiments may also include comparing the preferred facial image of the one of the individuals and pre-recorded facial images of the one of the individuals. Embodiments may also include determining identification of the one of the individuals who may be speaking. Embodiments may also include filtering, based on whether the lip movement of one of the individuals may be visible in the set of images and the identification of the one of the individuals, other sounds from the others of the plurality of individuals, and background sounds.

Embodiments of the present disclosure may also include a background noise filtering system based on multimodal AI, including a virtual agent that may be available for one or more users. Embodiments may also include one or more cameras and one or more microphones. In some embodiments, the one or more users interact via the one or more cameras and microphones that capture real-time inputs of their surroundings.

In some embodiments, upon the one or more users activating the virtual agent, a speaker's face and voice may be captured. In some embodiments, the speaker may be among the one or more users. In some embodiments, these signals may be used for the speaker re-identification. Embodiments may also include an AI engine that couples to the virtual agent and the one or more cameras and microphones.

In some embodiments, the AI engine uses re-identification to determine whether a given input audio signal may be from the speaker of interest. In some embodiments, background noise will be filtered out if any of the one or more users may be not speaking in the system's field of view. In some embodiments, a session starts when any of the one or more users may be visually detected in front of the system.

In some embodiments, the AI engine captures face and speech samples from the speaker to later perform re-identification. In some embodiments, the AI engine's confidence may be a function of the confidence of the re-identification recognition mechanism and the lip-sync detection mechanism. In some embodiments, the face and speech samples may be captured and encoded until the representation optimally discriminates.

In some embodiments, during a session, the AI engine decides whether a given input audio may be actual speech input for the virtual agent to interact with, provided that the individual currently using the system may be visually speaking, upon validating that a speaker may be the current user by comparing the visual and audio samples previously captured. In some embodiments, the session can be configured to one solo user or multiple users.

In some embodiments, the solo-user mode will only listed in the situation that the person that initiates the session may be actively speaking such that the system can detect their lip movement upon re-identifying. In some embodiments, multiple users may be allowed the system extends the re-identification to unique users that interacts in a given session.

In some embodiments, the sessions can consist of a single or multiple interactions. In some embodiments, the single-mode has a database reset each time it starts a new conversation, and multiple modes persist over time with a growing database. In some embodiments, single-mode persisting over multiple sessions can configure the virtual agent to only interact with that user.

In some embodiments, single mode for a single session ensures the virtual agent does not mistakenly respond to side conversations of bystanders of the individual using the system. In some embodiments, a mechanism ensures that audio noise may be not mistaken as input prompts for the one or more users. In some embodiments, speech from those around, but not using, the system, background music, or any other signal not intended to prompt the virtual agent can be considered noise. In some embodiments, multimodal can infer that the speaker of interest may be prompting the virtual agent. In some embodiments, multimodal may include video and audio signals.

### BRIEF DESCRIPTION OF THE FIGURES

FIG. 1 is a block diagram illustrating a background noise filtering system based on multimodal AI, according to some embodiments of the present disclosure.

FIG. 2A is a flowchart illustrating a method, according to some embodiments of the present disclosure.

FIG. 2B is a flowchart extending from FIG. 2A and further illustrating the method, according to some embodiments of the present disclosure.

FIG. 3 is a block diagram illustrating a background noise filtering system based on multimodal AI, according to some embodiments of the present disclosure.

FIG. 4 is a diagram showing an example of a method for providing services via a background noise filtering system based on multimodal AI, according to some embodiments of the present disclosure.

FIG. 5 is a diagram showing a second example of a method for providing services via a background noise filtering system based on multimodal AI, according to some embodiments of the present disclosure.

FIG. 6 is a diagram showing a third example of a method for providing services via a background noise filtering system based on multimodal AI, according to some embodiments of the present disclosure.

FIG. 7 is a diagram showing a fourth example of a method for providing services via a background noise filtering system based on multimodal AI, according to some embodiments of the present disclosure.

FIG. 8 is a diagram showing a fifth example of a method for providing services via a background noise filtering system based on multimodal AI, according to some embodiments of the present disclosure.

FIG. 9 is a diagram showing a sixth example of a method for providing services via a background noise filtering system based on multimodal AI, according to some embodiments of the present disclosure.

FIG. 10 is a diagram showing a seventh example of a method for providing services via a background noise filtering system based on multimodal AI, according to some embodiments of the present disclosure.

### DETAILED DESCRIPTION

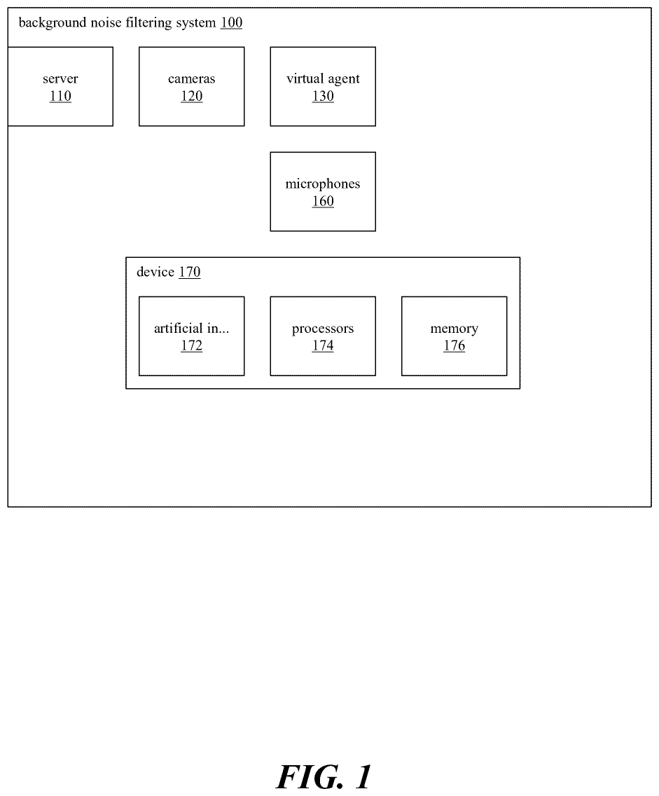

FIG. 1 is a block diagram that describes a background noise filtering system 100, according to some embodiments of the present disclosure. In some embodiments, the background noise filtering system 100 may include a server 110, one or more cameras 120 coupled to the server 110, one or more microphones 160 coupled to the server 110, a set of virtual agents 130 coupled to the one or more cameras 120 and the server 110, a device 170 coupled to the server 110, and recording audio from the one of the individuals by the one or more microphones 160.

In some embodiments, the background noise filtering system 100 may also record from the set of videos, for each individual, a preferred facial image for the individual. The background noise filtering system 100 may also have, based on whether the lip movement of one of the individuals may be visible in the set of images, at least one of a facial recognition algorithm and an audio algorithm to determine which individual may be speaking. The background noise filtering system 100 may also filter, based on whether the lip movement of one of the individuals may be visible in the set of images and the identification of the one of the individuals, other sounds from the others of the plurality of individuals, and background sounds.

In some embodiments, the set of virtual agents 130 may be configured to be displayed in LED/OLED displays, Android/iOS tablets, Laptops/PCs, smartphones, or VR/AR goggles. A set of multi-layer info panels coupled to the one or more processors may be configured to overlay graphics on top of the set of virtual agents. Any of the set of virtual agents 130 may be configured to be displayed with an appearance of an actual human or a humanoid or a cartoon character or an animated talking object.

In some embodiments, any of the set of virtual agents' gender, age and ethnicity may be determined by the artificial Intelligence's analysis on input from the user. Any of the set of customer-facing virtual agent may be configured to be displayed in whole or half body portrait mode. The virtual agent may serve to interact the users. The artificial intelligence engine may be configured for real-time speech recognition, speech-to-text generation, real-time dialog generation, text-to-speech generation, real-time lip animation to sync with speech, and avatar generation.

In some embodiments, the artificial intelligence engine may be configured to emulate different voices and use different languages. The device 170 may include an artificial intelligence engine 172 and one or more processors 174. The device 170 may also include memory 176 storing instructions that, when executed by one of the processors 174, cause the device 170 to: Obtain in real-time, from any of the one or more cameras 120, a set of videos of a plurality of individuals at a location.

In some embodiments, the artificial intelligence engine is configured to determine whether lip movement of one of the individuals may be visible in the set of images by comparing the audio recorded from the one of the individuals and pre-recorded audios that belong to the one of the individuals and comparing the preferred facial image of the one of the individuals and pre-recorded facial images of the one of the individuals. The artificial intelligence engine is configured to determine identification of the one of the individuals who may be speaking.

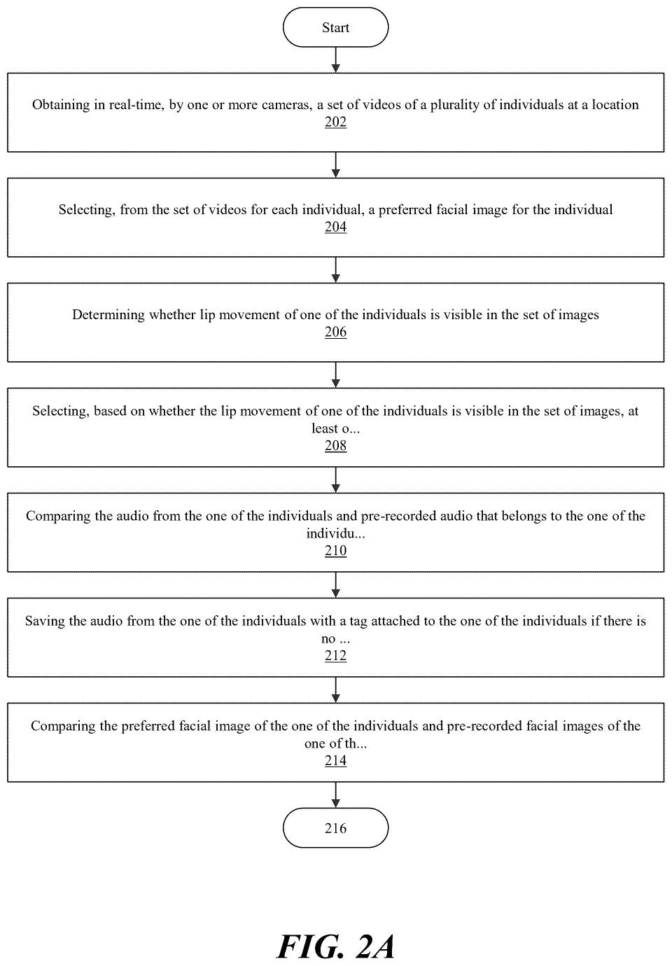

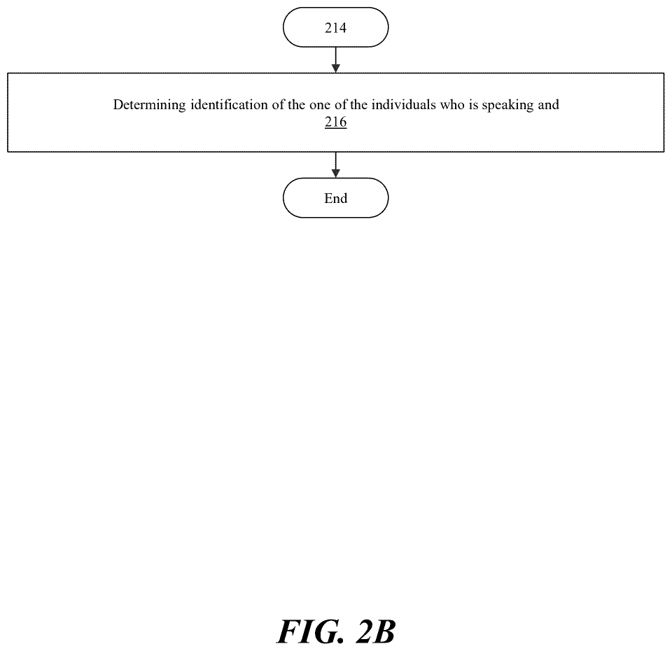

FIGS. 2A to 2B are flowcharts that describe a method, according to some embodiments of the present disclosure. In some embodiments, at 202, the method may include obtaining in real-time, by one or more cameras, a set of videos of a plurality of individuals at a location. At 204, the method may include selecting, from the set of videos for each individual, a preferred facial image for the individual. At 206, the method may include determining whether lip movement of one of the individuals may be visible in the set of images.

In some embodiments, at 208, the method may include selecting, based on whether the lip movement of one of the individuals may be visible in the set of images, at least one of a facial recognition algorithm and an audio algorithm to determine which individual may be speaking. At 210, the method may include comparing the audio from the one of the individuals and pre-recorded audio that belongs to the one of the individuals if there may be a pre-recorded audio exists.

In some embodiments, at 212, the method may include saving the audio from the one of the individuals with a tag attached to the one of the individuals if there may be no pre-recorded audio exists. At 214, the method may include comparing the preferred facial image of the one of the individuals and pre-recorded facial images of the one of the individuals. At 216, the method may include determining identification of the one of the individuals who may be speaking and.

In some embodiments, the set of virtual agents may be configured to be displayed in LED/OLED displays, Android/iOS tablets, Laptops/PCs, smartphones, or VR/AR goggles. A set of multi-layer info panels coupled to the one or more processors may be configured to overlay graphics on top of the set of virtual agents. Any of the set of virtual agents may be configured to be displayed with an appearance of a real human or a humanoid or a cartoon character.

In some embodiments, any of the set of virtual agents' gender, age and ethnicity may be determined by the artificial Intelligence's analysis on input from the user. Any of the set of customer-facing virtual agent may be configured to be displayed in whole body or half body portrait mode. The artificial intelligence engine may be configured for real-time speech recognition, speech to text generation, real-time dialog generation, text to speech generation, voice-driven animation, and human avatar generation.

In some embodiments, the artificial intelligence engine may be configured to emulate different voices and use different languages. A device with an artificial intelligence engine may be configured to be connected to one or more cameras and the set of virtual agents. A set of virtual agents coupled to the one or more cameras. The lip movements. Record audio from the one of the individuals by one or more microphones. Filtering, based on whether the lip movement of one of the individuals may be visible in the set of images and the identification of the one of the individuals, other sounds from the others of the plurality of individuals, and background sounds.

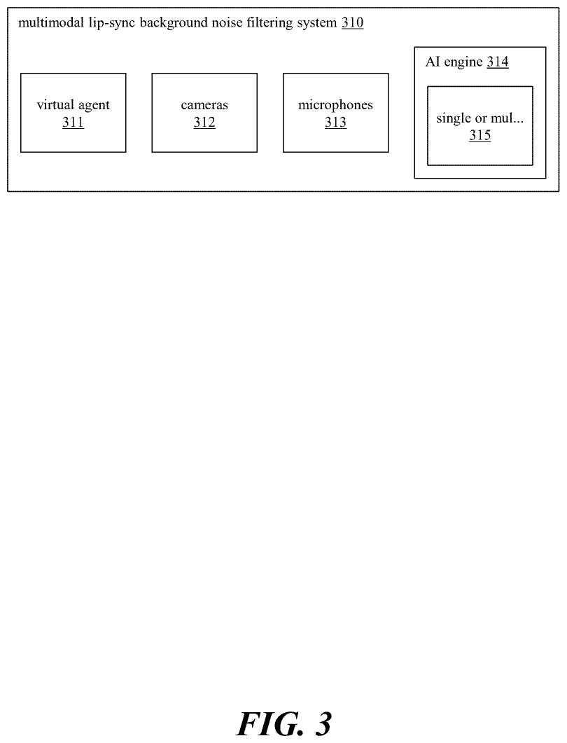

FIG. 3 is a block diagram that describes a background noise filtering system based on multimodal AI 310, according to some embodiments of the present disclosure. In some embodiments, the background noise filtering system based on multimodal AI 310 may include a virtual agent 311 that may be available for one or more users, one or more cameras 312, one or more microphones 313, and an AI engine 314 that couples to the virtual agent 311 and the one or more cameras 312 and microphones. The one or more users may interact via the one or more cameras 312 and microphones that capture real-time inputs of its surroundings.

In some embodiments, upon the one or more users activating the virtual agent 311, a speaker's face and voice may be captured. The speaker may be among the one or more users. These signals may be used for the speaker re-identification. The AI engine 314 may include a single or multiple interactions 315. The AI engine 314 may use re-identification to determine whether a given input audio signal may be from the speaker(s) of interest.

In some embodiments, background noise will be filtered out if any of the one or more users may be not speaking in the system's field of view. A session may start when any of the one or more users may be visually detected in front of the system 310. The AI engine 314 may capture face and speech samples from the speaker to later perform re-identification. The AI engine's confidence may be a function of the confidence of the re-identification recognition mechanism and the lip-sync detection mechanism.

In some embodiments, the face and speech samples may be captured and encoded until the representation optimally discriminates. During a session, the AI engine 314 decides whether a given input audio may be actual speech input for the virtual agent 311 to interact with, provided that the individual currently using the system 310 may be visually speaking, upon validating that a speaker may be the current user by comparing the visual and audio samples previously captured.

In some embodiments, the session can be configured to one solo user or multiple users. The solo-user mode will only listed in the situation that the person that initiates the session may be actively speaking such that the system 310 can detect their lip movement upon re-identifying. Multiple users may be allowed the system 310 may extend the re-identification to unique users that interacts in a given session. The sessions can.

In some embodiments, the AI engine 314 may perform a database reset each time it starts a new conversation, and perform multiple modes persist over time with a growing database. The database reset may include video and audio signals. Single-mode persisting over multiple sessions can configure the virtual agent 311 to only interact with that user. Single mode for a single session may ensure the virtual agent 311 may do not mistakenly respond to side conversations of bystanders of the individual using the system 310. A mechanism may ensure that audio noise may be not mistaken as input prompts for the one or more users. Speech from those around, but not using, the system 310, background music, or any other signal not intended to prompt the virtual agent 311 can be considered noise. Multimodal can infer that the speaker of interest may be prompting the virtual agent 311. Multimodal.

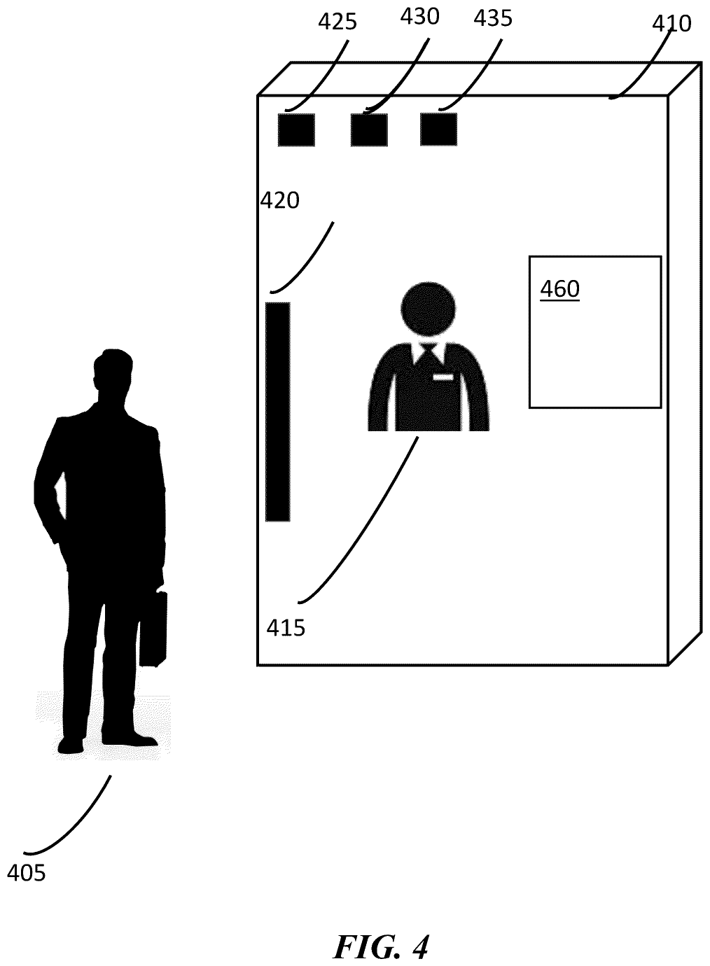

FIG. 4 is a diagram showing an example that describes the first example of a method for providing services via a background noise filtering system based on multimodal AI, according to some embodiments of the present disclosure.

In some embodiments, a user 405 can approach a smart display 410. In some embodiments, the smart display 410 could be LED or OLED-based. In some embodiments, interactive panels 420 are attached to the smart display 410. In some embodiments, camera 425, sensor 430 and microphone 435 are attached to the smart display 410. In some embodiments, an artificial intelligence visual assistant with customer-facing duty 415 is active on the smart display 410. In some embodiments, a leading visual agent is guiding the artificial intelligence visual assistant with customer-facing duty 415 without the knowledge of the artificial intelligence visual assistant with customer-facing duty 415. In some embodiments, a visual working agenda 460 is shown on the smart display 410. In some embodiments, user 405 can approach the smart display 410 and initiate and complete the intended business with the visual assistant 415 by the methods described in FIG. 1-FIG. 3. In some embodiments, interactive panel 420 is coupled to a central processor. In some embodiments, interactive panel 420 is coupled to a server via a wireless link. In some embodiments, user 405 can interact with the visual assistant 415 via camera 425, sensor 430 and microphone 435 using methods described in FIG. 1-FIG. 3, with the help of interactive panel 420. In some embodiments, user 405 can choose what language to use. In some embodiments, other users can use this service described in this paragraph. In some embodiments, the user is able to interact with multiple AI visual agents as described in this example and the system and methods described in FIG. 1-3.

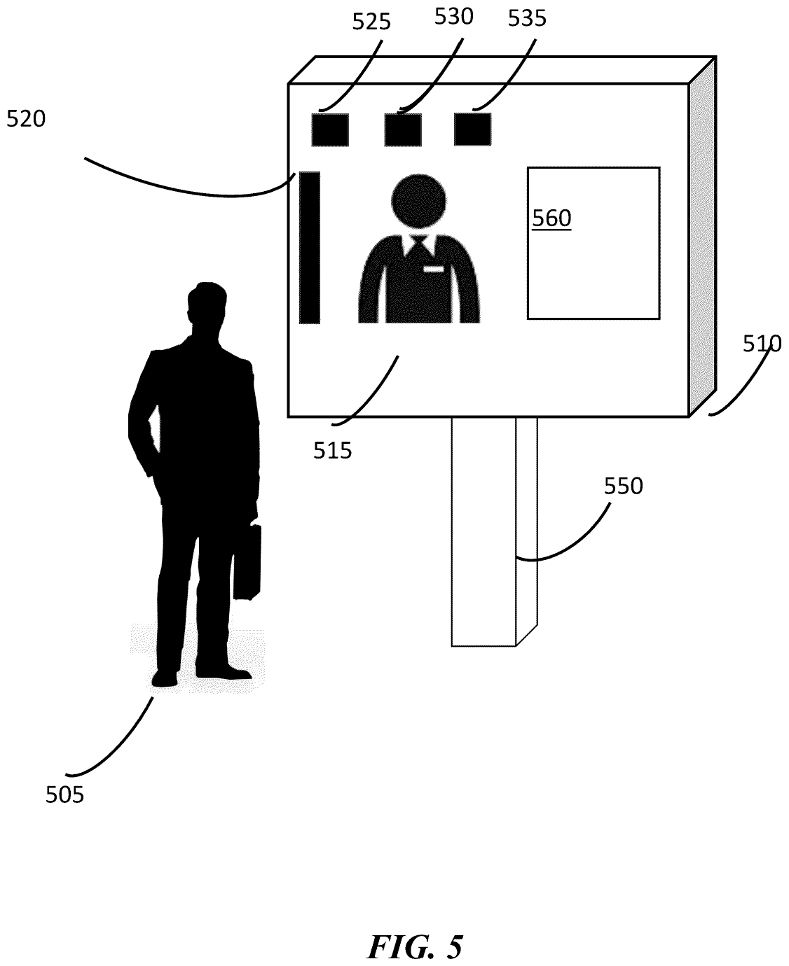

FIG. 5 is a diagram showing a second example of a method for providing services via a background noise filtering system based on multimodal AI, according to some embodiments of the present disclosure.

In some embodiments, a user 505 can approach a smart display 510. In some embodiments, the smart display 510 could be LED or OLED-based. In some embodiments, interactive panels 520 are attached to the smart display 510. In some embodiments, camera 525, sensor 530, and microphone 535 are attached to the smart display 510. In some embodiments, a support column 550 is attached to the smart display 510. In some embodiments, an artificial intelligence visual assistant with customer-facing duty 515 is active on the smart display 510. In some embodiments, a leading visual agent is guiding the artificial intelligence visual assistant with customer-facing duty 515 without the knowledge of the artificial intelligence visual assistant with customer-facing duty 515. In some embodiments, a visual working agenda 560 is shown on the smart display 510. In some embodiments, user 505 can approach the smart display 510 and initiate and complete the business process with the visual assistant 515 by the methods described in FIG. 1-FIG. 3. In some embodiments, interactive panel 520 is coupled to a central processor. In some embodiments, interactive panel 520 is coupled to a server via a wireless link. In some embodiments, user 505 can interact with the visual assistant 515 via camera 525, sensor 530 and microphone 535 using methods described in FIG. 1-FIG. 3, with the help of interactive panel 520. In some embodiments, user 505 can choose what language to be used. In some embodiments, other users can use this service descripted in this paragraph. In some embodiments, other users can use this service described in this paragraph. In some embodiments, the user can interact with multiple AI visual assistants as described in this example and the system and methods described in FIG. 1-3.

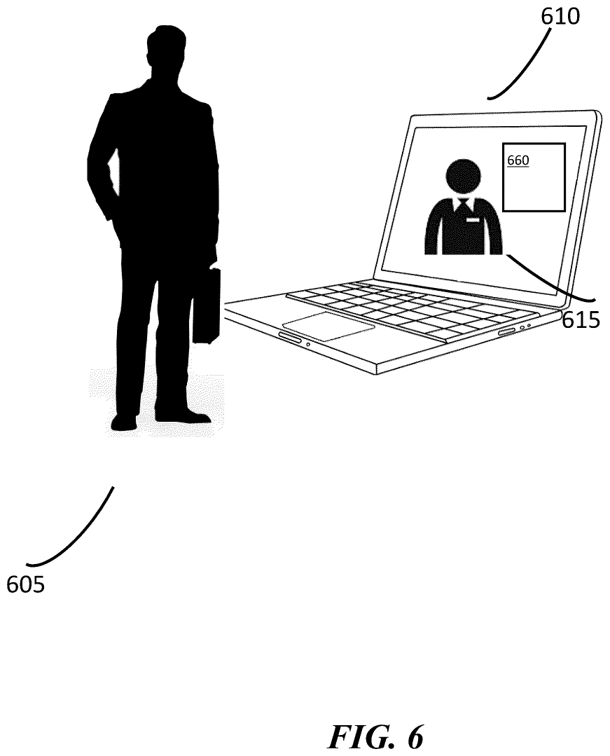

FIG. 6 is a diagram showing a third example of a method for providing services via a background noise filtering system based on multimodal AI, according to some embodiments of the present disclosure.

In some embodiments, a user 605 can approach a smart display 610. In some embodiments, the smart display 610 could be LED or OLED-based. In some embodiments, the display 610 could be a part of a desktop computer, a laptop computer or a tablet computer. In some embodiments, a camera, sensor, and microphone are attached to the smart display 610. In some embodiments, an artificial intelligence visual assistant 615 with customer-facing duty is active on the smart display 610. In some embodiments, a leading visual agent is guiding the artificial intelligence visual assistant with customer-facing duty 615 without the knowledge of the artificial intelligence visual assistant with customer-facing duty 615. In some embodiments, a visual working agenda 660 is shown on the smart display 610. In some embodiments, user 605 can approach the smart display 610 and initiate and complete the business process with the visual assistant 615 by the methods described in FIG. 1-FIG. 3. In some embodiments, a keyboard is coupled to a central processor. In some embodiments, a keyboard is coupled to a server via a wireless link. In some embodiments, user 605 can interact with the visual assistant 615 via a camera, sensor and microphone using methods described in FIG. 1-FIG. 3, with the help of the keyboard. In some embodiments, user 605 can choose what language to use. In some embodiments, other users can use this service descripted in this paragraph. In some embodiments, other users can use this service described in this paragraph. In some embodiments, the user is able to interact with multiple AI visual assistants as described in this example and the system and methods described in FIG. 1-3.

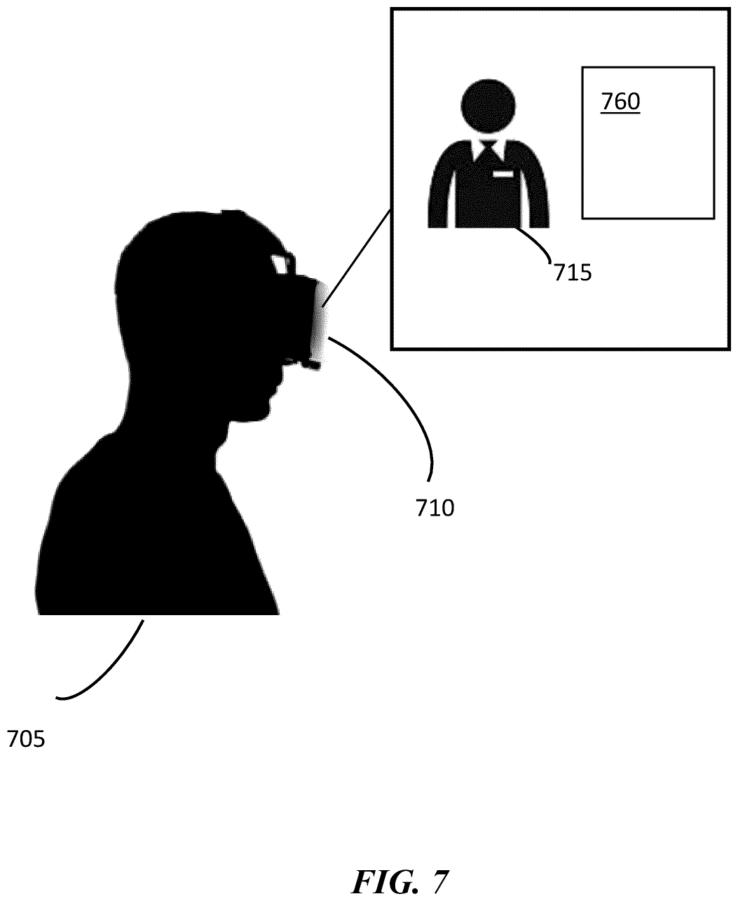

FIG. 7 is a diagram showing a fourth example of a method for providing services via a background noise filtering system based on multimodal AI, according to some embodiments of the present disclosure.

In some embodiments, a user 705 can view programs including news with a VR or AR device 710. In some embodiments, a processor and a server are connected to the VR or AR device 710. In some embodiments, an interactive keyboard is connected to the VR or AR device 710. In some embodiments, an AI visual assistant 715 with customer-facing duty is active on the VR or AR device 710. In some embodiments, a leading visual agent is guiding the AI visual assistant with customer-facing duty 715 without the knowledge of the AI visual assistant with customer-facing duty 715. In some embodiments, a visual working agenda 760 is shown on the VR or AR 710. In some embodiments, user 705 can initiate and complete the business process with the visual assistant 705 via the VR or AR device 715 by the methods described in FIG. 1-FIG. 3. In some embodiments, an interactive panel is coupled to a central processor. In some embodiments, an interactive panel is coupled to a server via a wireless link. In some embodiments, the user 705 can choose what language to use. In some embodiments, other users can use this service described in this paragraph. In some embodiments, other users can use this service described in this paragraph. In some embodiments, the user is able to interact with multiple AI visual assistants as described in this example and the system and methods described in FIG. 1-3.

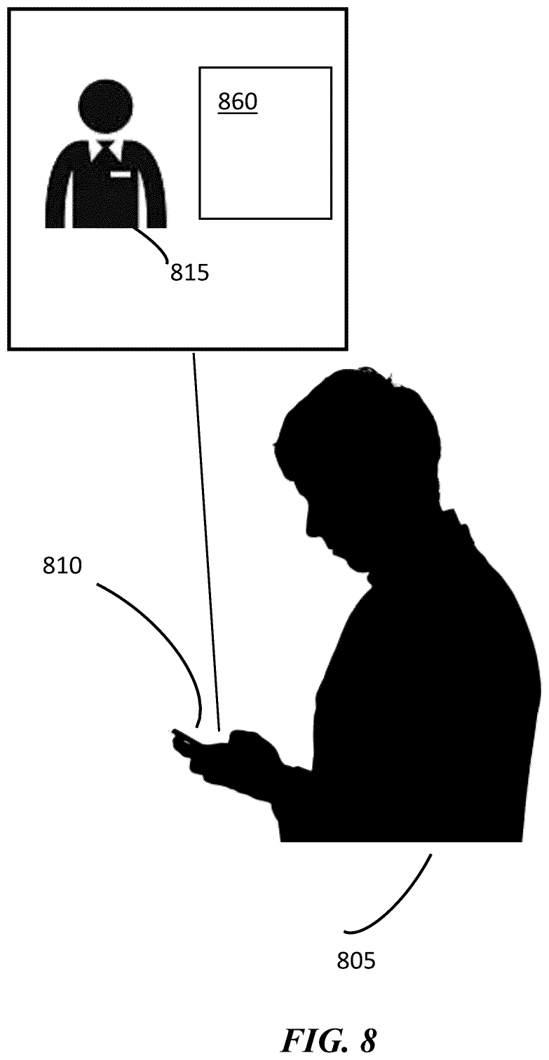

FIG. 8 is a diagram showing a fifth example of a method for providing services via a background noise filtering system based on multimodal AI, according to some embodiments of the present disclosure.

In some embodiments, a user 805 can view programs including news with a smartphone device 810. In some embodiments, a processor and a server are connected to the smartphone device 810. In some embodiments, an interactive keyboard is connected to the smartphone device 810. In some embodiments, an AI visual assistant 815 with customer-facing duty is active on the smartphone device 810. In some embodiments, a leading visual agent is guiding the AI visual assistant with customer-facing duty 815 without the knowledge of the AI visual assistant with customer-facing duty 815. In some embodiments, a visual working agenda 860 is shown on the smartphone device 810. In some embodiments, user 805 can initiate and complete the business process with the visual assistant 815 via smartphone device 810 by the methods described in FIG. 1-FIG. 3. In some embodiments, an interactive panel is coupled to a central processor. In some embodiments, interactive panel is coupled to a server via a wireless link. In some embodiments, the user 805 can choose what language to be used. In some embodiments, other users can use this service descripted in this paragraph. In some embodiments, other users can use this service described in this paragraph. In some embodiments, the user is able to interact with multiple AI visual assistants as described in this example and the system and methods described in FIG. 1-3.

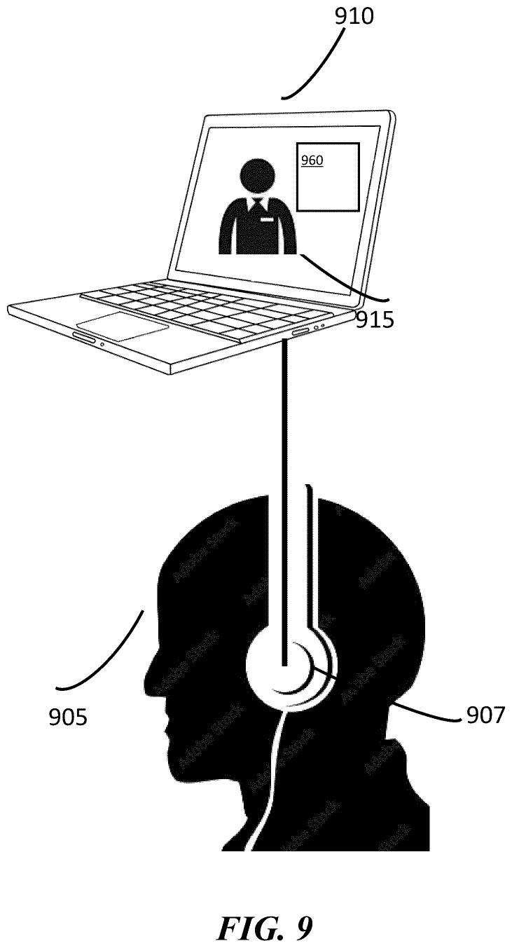

FIG. 9 is a diagram showing a sixth example of a method for providing services via a background noise filtering system based on multimodal AI, according to some embodiments of the present disclosure.

In some embodiments, a user 905 has a brain-computer interface. In some embodiments, the user 905 may wear a headset 907 that can detect and translate the electric signal from the brain and communicate with the computer or other devices. The computer 910 or other devices are connected with a cable or wire to the headset. In some embodiments, a processor and a server are connected to the computer 910. In some embodiments, an interactive keyboard is connected to the computer 910. In some embodiments, an AI visual assistant 915 with customer-facing duty is active on the computer 910. In some embodiments, a leading visual agent is guiding the AI visual assistant with customer-facing duty 915 without the knowledge of the AI visual assistant with customer-facing duty 915. In some embodiments, a visual working agenda 960 is shown on the computer 910. In some embodiments, user 905 can initiate and complete the business process with the visual assistant 905 via the computer 915 by the methods described in FIG. 1-FIG. 3. In some embodiments, an interactive panel is coupled to a central processor. In some embodiments, an interactive panel is coupled to a server via a wireless link. In some embodiments, the user 905 can choose what language to use. In some embodiments, other users can use this service descripted in this paragraph. In some embodiments, other users can use this service described in this paragraph. In some embodiments, the user is able to interact with multiple AI visual assistants as described in this example and the system and methods described in FIG. 1-3.

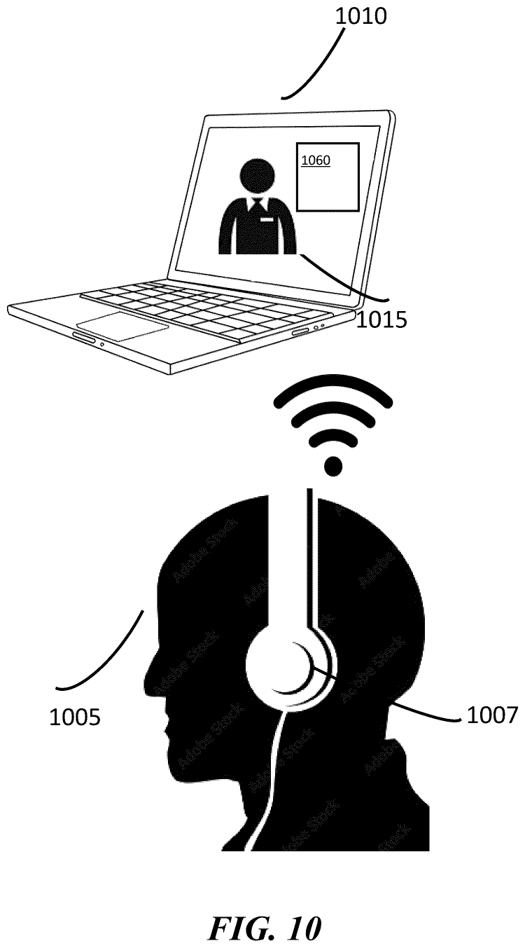

FIG. 10 is a diagram showing a seventh example of a method for providing services via a background noise filtering system based on multimodal AI, according to some embodiments of the present disclosure.

In some embodiments, a user 1005 has a brain-computer interface. In some embodiments, the user 1005 may wear a headset 1007 that can detect and translate the electric signal from the brain and communicate with the computer or other devices. The computer 1010 or other devices are connected with wireless means to the headset. In some embodiments, a processor and a server are connected to the computer 1010. In some embodiments, an interactive keyboard is connected to the computer 1010. In some embodiments, an AI visual assistant 1015 with customer-facing duty is active on the computer 1010. In some embodiments, a leading visual agent is guiding the AI visual assistant with customer-facing duty 1015 without the knowledge of the AI visual assistant with customer-facing duty 1015. In some embodiments, a visual working agenda 1060 is shown on the computer 1010. In some embodiments, user 1005 can initiate and complete the business process with the visual assistant 1005 via the computer 1015 by the methods described in FIG. 1-FIG. 3. In some embodiments, an interactive panel is coupled to a central processor. In some embodiments, an interactive panel is coupled to a server via a wireless link. In some embodiments, the user 1005 can choose what language to use. In some embodiments, other users can use this service descripted in this paragraph. In some embodiments, other users can use this service described in this paragraph. In some embodiments, the user is able to interact with multiple AI visual assistants as described in this example and the system and methods described in FIG. 1-3.

1. A background noise filtering system based on multimodal AI, comprising:
a server;
one or more cameras coupled to a server;
one or more microphones coupled to the server,
a set of virtual agent coupled to the one or more cameras and the server, wherein the set of virtual agent are configured to be displayed in LED/OLED displays, Android/iOS tablets, Laptops/PCs, smartphones, or VR/AR goggles, wherein a set of multi-layer info panels coupled to the one or more processors are configured to overlay graphics on top of the set of virtual agents, wherein any of the set of virtual agent are configured to be displayed with an appearance of an actual human or a humanoid or a cartoon character or an animated talking object, wherein any of the set of virtual agents' gender, age and ethnicity is determined by the artificial Intelligence's analysis on input from the user, wherein any of the set of customer-facing virtual agent is configured to be displayed in whole or half body portrait mode, wherein the virtual agent serves to interact users, wherein the artificial intelligence engine is configured for real-time speech recognition, speech-to-text generation, real-time dialog generation, text-to-speech generation, real-time lip animation to sync with speech, and avatar generation, wherein the artificial intelligence engine is configured to emulate different voices and use different languages; and
a device coupled to the server, wherein the device comprising an artificial intelligence engine and one or more processors and memory storing instructions that, when executed by one of the processors, cause the device to:
obtain in real-time, from any of the one or more cameras, a set of videos of a plurality of individuals at a location,
select, from the set of videos, for each individual, a preferred facial image for the individual,
determine whether lip movement of one of the individuals is visible in the set of images, and
select, based on whether the lip movement of one of the individuals is visible in the set of images, at least one of a facial recognition algorithm and an audio algorithm to determine which individual is speaking, wherein the lip movements,
record audio from the one of the individuals by the one or more microphones,
compare the audio from the one of the individuals and pre-recorded audios that belong to the one of the individuals,
compare the preferred facial image of the one of the individuals and pre-recorded facial images of the one of the individuals,
determine identification of the one of the individuals who is speaking and
filter, based on whether the lip movement of one of the individuals is visible in the set of images and the identification of the one of the individuals, other sounds from the others of the plurality of individuals, and background sounds.

2. A method to identify speakers and filter background noise with Artificial intelligence comprising:
obtaining in real-time, by one or more cameras, a set of videos of a plurality of individuals at a location, wherein the set of virtual agent are configured to be displayed in LED/OLED displays, Android/iOS tablets, Laptops/PCs, smartphones, or VR/AR goggles, wherein a set of multi-layer info panels coupled to the one or more processors are configured to overlay graphics on top of the set of virtual agents, wherein any of the set of virtual agent are configured to be displayed with an appearance of a real human or a humanoid or a cartoon character, wherein any of the set of virtual agents' gender, age and ethnicity is determined by the artificial Intelligence's analysis on input from the user, wherein any of the set of customer-facing virtual agent is configured to be displayed in whole body or half body portrait mode, wherein the artificial intelligence engine is configured for real-time speech recognition, speech to text generation, real-time dialog generation, text to speech generation, voice-driven animation, and human avatar generation, wherein the artificial intelligence engine is configured to emulate different voices and use different languages, wherein a device with an artificial intelligence engine is configured to be connected to one or more cameras and the set of virtual agent;
selecting, from the set of videos for each individual, a preferred facial image for the individual, wherein a set of virtual agents coupled to the one or more cameras;
determining whether lip movement of one of the individuals is visible in the set of images;
selecting, based on whether the lip movement of one of the individuals is visible in the set of images, at least one of a facial recognition algorithm and an audio algorithm to determine which individual is speaking, wherein the lip movements;
record audio from the one of the individuals by one or more microphones;
comparing the audio from the one of the individuals and pre-recorded audio that belongs to the one of the individuals if there is a pre-recorded audio exists;
saving the audio from the one of the individuals with a tag attached to the one of the individuals if there is no pre-recorded audio exists;
comparing the preferred facial image of the one of the individuals and pre-recorded facial images of the one of the individuals;
determining identification of the one of the individuals who is speaking and
filtering, based on whether the lip movement of one of the individuals is visible in the set of images and the identification of the one of the individuals, other sounds from the others of the plurality of individuals, and background sounds.

3. A multimodal lip-sync background noise filtering system, comprising:
A virtual agent that is available for one or more users,
One or more cameras and one or more microphones, wherein the one or more users interact via the one or more cameras and microphones that capture real-time inputs of its surroundings, wherein upon the one or more users activating the virtual agent, a speaker's face and voice are captured, wherein the speaker is among the one or more users, wherein these signals are used for the speaker re-identification,
An AI engine that couples to the virtual agent and the one or more cameras and microphones, wherein the AI engine uses re-identification to determine whether a given input audio signal is from the speaker(s) of interest, wherein background noise will be filtered out if any of the one or more users are not speaking in the system's field of view, wherein a session starts when any of the one or more users are visually detected in front of the system, wherein the AI engine captures face and speech samples from the speaker to later perform re-identification, wherein the AI engine's confidence is a function of the confidence of the re-identification recognition mechanism and the lip-sync detection mechanism, wherein the face and speech samples are captured and encoded until the representation optimally discriminates, wherein during a session, the AI engine decides whether a given input audio is actual speech input for the virtual agent to interact with, provided that the individual currently using the system is visually speaking, upon validating that a speaker is the current user by comparing the visual and audio samples previously captured, wherein the session can be configured to one solo user or multiple users, wherein the solo-user mode will only listed in the situation that the person that initiates the session is actively speaking such that the system can detect their lip movement upon re-identifying, wherein multiple users are allowed the system extends the re-identification to unique users that interacts in a given session, wherein the sessions can consist of a single or multiple interactions, wherein the single-mode has a database reset each time it starts a new conversation, and multiple modes persist over time with a growing database, wherein single-mode persisting over multiple sessions can configure the virtual agent to only interact with that user, wherein single mode for a single session ensures the virtual agent does not mistakenly respond to side conversations of bystanders of the individual using the system, wherein a mechanism ensures that audio noise is not mistaken as input prompts for the one or more users, wherein speech from those around, but not using, the system, background music, or any other signal not intended to prompt the virtual agent can be considered noise, wherein multimodal can infer that the speaker of interest is prompting the virtual agent, wherein multimodal comprises video and audio signals.
